(19) United States
(12) Patent Application Publication
(10) Pub. No.: US 2012/0330971 A1
(43) Pub. Date: Dec. 27, 2012

(54) ITEMIZED RECEIPT EXTRACTION USING MACHINE LEARNING

(75) Inventors: James Thomas, Amagansett, NY (US); Gopali Contractor, Edison, NY (US); Thomas L. Packer, Orem, UT (US); Michael A. Haley, New York, NY (US)

(73) Assignee: ITEMIZE LLC, New York, NY (US)

(21) Appl. No.: 13/532,863

(22) Filed: Jun. 26, 2012

Related U.S. Application Data
(60) Provisional application No. 61/501,222, filed on Jun. 26, 2011.

(51) Int. Cl. G06F 17/30

(52) U.S. Cl. 707/748; 707/E17.005; 707/E17.033

(57) ABSTRACT

A method, including retrieving a transaction receipt, wherein the transaction receipt includes unstructured data. Features indicating details of the transaction are extracted from the unstructured data, and using a receipt language model, weights are applied to the features. Based on the features and the weights, labels are associated with tokens in the receipt, and the receipt language model is updated with the extracted features, the applied weights and the associated labels.

### CROSS-REFERENCE TO RELATED APPLICATIONS

This application claims the benefit of U.S. Provisional Patent Application 61/501,222, filed Jun. 26, 2011, which is incorporated herein by reference.

### FIELD OF THE INVENTION

The present invention relates generally to machine learning, and specifically to using machine learning to extract transaction information from digital shopping receipts.

### BACKGROUND

Machine learning is a computer science discipline concerned with the design and development of algorithms that allow computers to evolve behaviors based on empirical data, such as from sensor data or databases. Typically, the goal of a machine learning algorithm is to improve its own performance through the use of a model that employs artificial intelligence techniques to mimic the ways by which humans seem to learn, such as repetition and experience. For example, a machine learning algorithm can be configured to take advantage of examples of data to capture characteristics of interest of the data's unknown underlying probability distribution. In other words, data can be seen as examples that illustrate relations between observed variables.

### SUMMARY OF THE INVENTION

There is provided, in accordance with an embodiment of the present invention, a method, including retrieving, by a computer, a transaction receipt including unstructured data, extracting features indicating details of the transaction from the unstructured data, applying, using a receipt language model, weights to the features, associating, based on the features and the weights, labels with tokens in the receipt, the tokens including values stored in the unstructured data, and updating the receipt language model with the extracted features, the applied weights and the associated labels.

There is also provided, in accordance with an embodiment of the present invention, an apparatus, including a memory configured to store a transaction receipt including unstructured data, and a processor configured to extract features indicating details of the transaction from the unstructured data, to apply, using a receipt language model, weights to the features, to associate, based on the features and the weights, labels with tokens in the receipt, the tokens including values stored in the unstructured data, and to update the receipt language model with the extracted features, the applied weights and the associated labels.

There is further provided, in accordance with an embodiment of the present invention, a computer software product including a non-transitory computer-readable medium, in which program instructions are stored, which instructions, when read by a computer executing a user interface, cause the computer to retrieve a transaction receipt including unstructured data, to extract features indicating details of the transaction from the unstructured data, to apply, using a receipt language model, weights to the features, associate, based on the features and the weights, labels with tokens in the receipt, the tokens including values stored in the unstructured data, and to update the receipt language model with the extracted features, the applied weights and the associated labels.

### BRIEF DESCRIPTION OF THE DRAWINGS

The disclosure is herein described, by way of example only, with reference to the accompanying drawings, wherein:

FIG. 1 is a schematic, pictorial illustration of a computer system configured to extract item level information from transaction receipts, in accordance with an embodiment of the present invention;

FIG. 2 is a flow diagram that schematically illustrates a method of training the computer system to accurately extract item level information from training receipts, in accordance with an embodiment of the present invention;

FIG. 3 is an illustration of a sample training receipt used for training an Receipt Language Model, in accordance with an embodiment of the present invention;

FIG. 4 is an illustration of tokens and features in the sample training receipt identified by a Preprocessing Module, in accordance with an embodiment of the present invention;

FIG. 5 is an illustration of additional features of the sample training receipt identified by a Feature Extraction Module, in accordance with an embodiment of the present invention;

FIG. 6 an illustration of labels that the Receipt Language Model identified and extracted from the sample training receipt, in accordance with an embodiment of the present invention;

FIG. 7 is a flow diagram that schematically illustrates a method of testing and evaluating accuracy of the Receipt Language Model, in accordance with an embodiment of the present invention;

FIGS. 8A and 8B are illustrations of sections of an accuracy report for the Receipt Language Model, in accordance with an embodiment of the present invention;

FIG. 9 is a flow diagram that schematically illustrates a method of processing a receipt during live execution of the Machine Learning-Based Sequence Labeling Module, in accordance with an embodiment of the present invention;

FIG. 10 is a flow diagram that schematically illustrates a method for updating the Receipt Language Model while processing the exception receipt, in accordance with an embodiment of the present invention; and

FIG. 11 is a process flow diagram that schematically illustrates how the computer system processes receipts to update the Itemize Database, in accordance with an embodiment of the present invention.

### DETAILED DESCRIPTION OF EMBODIMENTS

In addition to traditional retail “brick and mortar” merchants, the continuing growth of electronic commerce (e-commerce) has resulted in a corresponding increase in merchants selling products over the Internet. Typically, each merchant produces (i.e., either prints or emails) receipts in a different format. The receipts can include information such as the merchant name, a transaction date, and a description and a price of each item purchased.

Two common receipt layouts used (with different variations) by merchants are Vertical Layouts and Horizontal Layouts. Vertical Receipts present a header line (e.g., Description, Size, Price, Quantity), followed by purchased items (i.e., details corresponding to the header for each purchased item) on subsequent separate lines, typically in a tabular format. Horizontal Layouts present each header on a separate line, followed by a value on the same line (e.g., Price: $9.95).

Embodiments of the present invention provide methods and systems for using machine learning to extract transaction (e.g., merchant and amount) and item level (e.g., description, unit price) details from electronic (typically emailed) and scanned physical receipts. In some embodiments, a Training Mode is first employed to train a Receipt Language Model (also referred to herein as the model) that is configured to extract labels (from a receipt. The labels comprise descriptions of values (i.e., transaction information) in the receipts, e.g., (but not limited to) merchant, transaction date, and line item information.

During the Training Mode, training receipts from an initial set of merchants (e.g., the top 250 e-commerce merchants by sales) are loaded into the system, initial features and weights configured to extract the labels from the training receipts are entered (manually), and the Receipt Language Model is trained using the labels that were applied to the training receipts by the initial features and weights.

During the Live Execution Mode, the Receipt Language Model (based on the initial feature and weights) is used to process subsequent receipts, which may include receipts from merchants that were not included in the Training Mode and the Test-Evaluation Mode. When processing a subsequent receipt from a new merchant, the Receipt Language Model attempts to identify the subsequent receipt's labels based on the features and their corresponding already incorporated into the model. In some embodiments, the features and their corresponding used by the Receipt Language Model during the Live Execution Mode may be different that the rules used during the Training and the Test-Evaluate Modes. For example, the Receipt Language Model used during the Live Execution Mode may comprise a statistical model.

If the Receipt Language Model fails an automated verification test (e.g., every labeled item description has an associated price) for the subsequent receipt, then the subsequent automatically invalidated receipt is forwarded to a Business Process Outsourcing (BPO) Analyst, who can (manually) correct the subsequent receipt. This manually corrected training example defined by the BPO Analyst is typically saved to the system, and used to update the Receipt Language Model with updated training data.

Each extracted label is typically associated with specific data in the receipt. For example, a transaction date label can be associated with a text block (also referred to herein as a token) “Jun. 6, 2011” that was identified at a specific location on a receipt. Embodiments of the present invention can populate a database with labels and tokens from transaction receipts submitted by a large population of consumers. Once populated, data mining tools can analyze the database, and perform operations such as empirical reporting, profiling, segmentation, scoring, forecasting, and propensity target modeling. The data mining operations described supra can enable the database to be used for marketing applications, for example, creating a closed loop marketing system based on matching itemized receipt-based customer profiles to scored merchant offers.

### SYSTEM DESCRIPTION

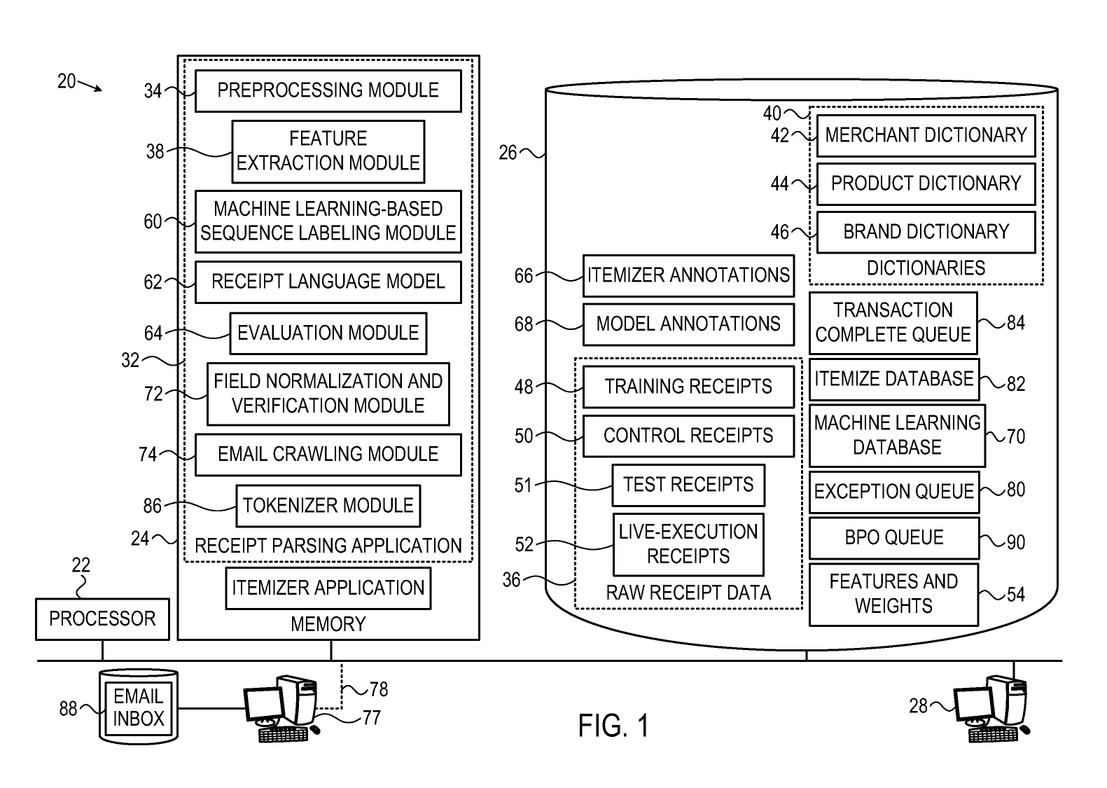

FIG. 1 is a schematic, pictorial illustration of a system configured to extract item level information from a transaction receipt, in accordance with an embodiment of the present invention. System 20 comprises a processor 22, a memory 24, a storage device 26 and a local workstation 28, which are all coupled via a bus 30. Processor 22 executes a Receipt Parsing Application 32 comprising multiple modules as described in further detail hereinbelow.

In operation, a Preprocessing module 34 retrieves a given receipt from Raw Receipt Data 36, and uses Hypertext Markup Language (HTML) to identify possible features from the given receipt. A Tokenizer module 74 is configured to extract tokens from the raw receipt data (also referred to herein as unstructured receipt data). The tokens comprise potentially relevant values stored in the data (relevancy can be determined by a machine learning based sequencing labeling tool described hereinbelow) in the retrieved receipt, and the features comprise descriptions of the tokens. For example, the feature FEA_HTMLCOLHEADER_ITEM_PRICE for a given token “$13.95” can indicate that Modules 34 and 74 found the text “Item Price” in an HMTL column header that was above the given token (i.e., “$13.95”).

Examples of values stored in the receipt data include, but are not limited to merchant names, item names, item descriptions, item categories (e.g., electronics, apparel, and housewares), item prices, sales tax amounts, shipping charges, handling charges, discounts, adjustments and total transaction amounts.

Raw Receipt Data 36 comprises electronic receipts and/or scanned receipts for purchases. The electronic receipts typically comprise HTML formatted purchase receipts that were emailed from a merchant to a customer. The scanned receipts typically comprise images of physical store receipts that were scanned into system 20 via a scanning device such as a digital camera embedded in a smartphone (not shown).

A Feature Extraction Module 38 is configured to receive the tokens and the features extracted by Modules 34 and 74, and then identify any additional features of the tokens. Tokens comprise values in the receipt data, and features comprise attributes of the token's content and/or context. For example, when processing the “$13.95” token described supra, Feature Extraction Module 38 can identify fields such as:
FEA_DECIMAL: There is a decimal point in the extracted token.
FEA_HTMLCOLHEADER_ITEM_PRICE: Feature Extraction Module 38 identified table header “Item Price” either above or immediately preceding the extracted token (i.e., on the same line).
FEA_DOLLARSIGN: There is a dollar sign (“$”) in the extracted token.

Feature Extraction Module 38 can use data stored in a Dictionaries 40 to help identify the features (i.e., attributes) of the extracted tokens. Dictionary 40 may comprise individual dictionaries, such as a Merchant Dictionary 42 that can be used to identify a merchant for the transaction, a Product Dictionary that can be used to identify individual line items of the transaction, and a Brand Dictionary 46 that can be used to identify one or more brands purchased in the transaction.

In some embodiments, Feature Extraction Module 38 may extract a first set of features from the electronic receipts and a second set of features from the scanned receipts, wherein the second set comprises a subset of the first set. For example, the second set of features (i.e., the subset) may include features associated with fields (i.e., target data to be mined) such as:
Merchant name.
Transaction date.
Total transaction amount.
Item brand (if available).

In addition to the second set of features, the first set of features may include features associated with fields such as:
Product name (for each line item).
Product quantity (for each line item).
Product Price (for each line item).
Address (of the customer).

As described in further detail hereinbelow, Receipt Parsing Application 32 operates in a Training Mode, a Test-Evaluate Mode, or a Live-Execution Mode. In some embodiments, Receipt Parsing Application 32 may access different Raw Receipt Data 36 during each of the modes. For example, Raw Receipt Data 36 may comprise Training Receipts 48 and Test Receipts 51 during the Training Mode, Control Receipts 50 and Test Receipts 51 during the Test-Evaluate Mode, and Live-Execution Receipts 52 during the Live-Execution Mode.

During the Training Mode, Training Receipts 48 may comprise transaction receipts from the top (in terms of revenue) 250 e-commerce merchants. Via local workstation 28, a Business Process Outsourcing (BPO) Analyst (not shown) can input Features and Weights 54 for the e-commerce merchants included in Training Receipts 48.

Using Training Receipts 48 and Features and Weights 54, a Machine Learning-Based Sequence Labeling Module 60 (also referred to herein as Module 60) defines a Receipt Language Model 62 that is used by Receipt Parsing Application 32 to extract transaction and item level details from Receipt Data 36. In some embodiments, Module 60 comprises a linear-chain conditional random field toolkit or a statistical sequence labeling toolkit. As described in detail hereinbelow, as system processes additional receipts (during training and live execution), Features and Weights 54 can be automatically updated as needed in order to increase receipt data extraction accuracy.

Module 60 can comprise a software package such as “MAchine Learning for Language Tool”, also known as “MALLET”. MALLET (http://mallet.cs.umass.edu/) is an open source Java™ based software package used for statistical natural language processing, document classification, cluster analysis, information extraction, and other machine learning applications for text-based data.

In embodiments of the present invention, Receipt Parsing Application 32 applies Receipt Language Model 62 to the extracted tokens and features from Feature Extraction Application 38, in order to predict labels for the extracted tokens. The labels and their associated tokens comprise the relevant transaction details. Examples of labels include:
merchant_name refers to a token containing the merchant's name.
receipt_date refers to a token containing a receipt date.
item_description refers to token containing a description of a purchased item.
item_price refers to a token containing a price of an item purchased.
total_price refers to a token containing the total amount of the purchase.

When creating Receipt Language Model 62, Module 60 can use algorithms such as a Hidden Markov Model (HMM), a Maximum Entropy Markov Model (MEMM), and a Conditional Random Field (CRF).

During the Test-Evaluate Mode, an Evaluation Module 64 may compare pairs of receipts, where each pair of receipts comprises a first receipt from Control Receipts 50 and a second receipt from Test Receipts 51. Control Receipts 50 comprise transaction receipts, typically from e-commerce merchants included in Training Receipts 48, whose tokens and features are input (i.e., hand labeled) by the BPO Analyst via local workstation 28. Test Receipts 51 comprise transaction receipts that were automatically labeled by Module 60, using Receipt Language Model 62.

In operation, workstation 28 accesses an Itemizer Application 86 on system 20 that enables the BPO analyst to identify features on a given receipt. Itemizer Application 86 stores the identified featured to an Itemizer Annotation File 66 that is used by Module 60 to update Model 62.

In some embodiments the Itemizer Application labels Control Receipts 50 in a stand-off file format, where the extracted field information (i.e., the tokens and features) are stored to Itemizer Annotation File 66. For example, Itemizer Annotation File 66 can be a simple tab-delimited or Extensible Markup Language (XML) file containing label-text pairs, e.g. (“Product Name”, “Acme Shoebox Holder”) or (“Product Price”, “$10.00”). In some embodiments, Itemizer Annotation File 66 may comprise a list of these label-text pairs.

Evaluation Module 64 is configured to compare Hand Annotation File 66 to a Model Annotation File 68 that was output from Module 60 using Receipt Language Model 62. Evaluation Module 64 retrieves and compares corresponding receipts in Hand Annotation File 66 and Automatic Annotation File 68, and outputs a report file. The actual receipt files (i.e., Control Receipts and Test Receipts 51) do not need to be processed by Evaluation Module 64, since the Evaluation Module can simply compare the labels stored in Itemizer Annotation File 66 and Model Annotation File 68.

After loading Itemizer Annotation File 66 and Model Annotation File 68, Evaluation Module 64 can compare the two annotated files by maintaining running total counts of three event types. The following are event types for a specific label X:
A true positive (TP) comprises an instance where a span of text is labeled as X in both Itemizer Annotation File 66 and Model Annotation File 68.
A false positive (FP) comprises an instance where Feature Extraction Module 38 labels a span of text as X but Itemizer Annotation File 66 does not contain that span of text with label X (e.g., the hand annotation file may or may not contain the same span of text with a different label, Y).
A false negative (FN) comprises an instance where Itemizer Annotation File 66 contains a span of text with label X but Model Annotation File 68 does not contain a corresponding span of text with label X.

Evaluation Module 64 can maintain each of these three event type counts (i.e., TP, FP and FN) for each of the field labels identified in Itemizer Annotation File 66 and Model Annotation File 68. Additionally, Evaluation Module 64 can accumulate a total for each of the event type counts, thereby combining all field labels into aggregate counts. After accumulating the totals, for these three event types (i.e., three counts per label and three counts for the totals), the following three metric can be calculated as follows:

Precision=TP/(TP+FP) (1)

Recall=TP/(TP+FN) (2)

F-measure=2*Precision*Recall/(Precision+Recall) (3)

The three metrics referenced by Equations (1), (2) and (3) can be used to indicate the accuracy of Feature Extraction Module 38. Precision indicates the accuracy of the extracted information, and Recall indicates how much of the desired information in the receipts is being extracted by Feature Extraction Module 38. F-measure is an enhanced average (harmonic mean of precision and recall) comprises an overall quality score that summarizes Precision and Recall. For example, F-measure can be used to compare the accuracy of two different implementations of Feature Extraction Module 38. In operation, Evaluation Module 64 stores the calculated accuracy metrics to a Machine Learning Database 70.

Receipt Parsing Application 32 also comprises a Field Normalization and Verification Module 72 that is configured to “normalize” the tokens (i.e., the data) associated with the labels extracted by Module 60 by:
Using Dictionaries 40 to correct misspelled extracted text. The misspellings can be either spelling errors (e.g., “Blowse” instead of “Blouse”), or text that was abbreviated in order to fit on a display of a Point of Sale (POS) system (not shown). For example, “Speakers” can be shortened to “SPKRS”.
Using Dictionaries 40 to identify additional information on an extracted item. For example, using Product Dictionary 44 and Brand Dictionary 46, Field Normalization Module 72 can identify a brand name for an extracted product.

Module 74 is also configured to check the validity of tokens extracted by Preprocessing Module 34 against a set of features and weights stored in file 54. For example, a given rule “receipt-date” can check to see if the transaction date is (a) within a specific number of days prior to the date that the receipt was emailed to the customer, (b) is a valid date, and (c) is positioned near the beginning (i.e., the top) of the receipt.

During the Live Execution Mode, an Email Crawling Module 76 retrieves receipt data 36 from a user's remote computer 77, typically coupled to system 20 via an Internet Connection 78. Email Crawling Module 76 can be configured to periodically scan an Email Inbox 88, and identify emails containing electronic receipts (i.e., Live-Execution Receipts 52 to be parsed by system 20). In some embodiments, the first time Email Crawling Module 42 accesses Remote Computer 77, the Email Crawling Module can retrieve electronic receipts going back a specific period of time, for example, 18 months. While the configuration in Figure shows Email Inbox 88 stored on Remote Computer 77, other configurations for the Email Inbox are considered to be within the spirit and scope of the present invention. For example, Email Inbox 88 may comprise a web-based email inbox such as a Gmail™ inbox or a Hotmail™ inbox

As described in detail hereinbelow, during the Live-Execution Mode, Receipt Parsing Application 32 may process a receipt from a new merchant that was not included in Training Receipts 48, Control Receipts 50 or Test Receipts 51. The receipts from new merchants are loaded to an Exception Queue 80 for processing by Receipt Parsing Application 32. If Receipt Parsing Application 32 cannot successfully extract information from the new merchant receipt, then the receipt from the new merchant is forwarded to a BPO queue 90 for manual processing.

During the Live-Execution Mode, tokens and labels that are successfully extracted from Live-Execution Receipts 52 (i.e., from both existing and new merchants) are stored to an Itemize Database 82 via a Transaction Complete Queue 84.

Processor 22 typically comprises a general-purpose computer processor, which is programmed in software to carry out the functions described hereinbelow. The software may be downloaded to the processor in electronic form, over a network, for example, or it may alternatively be provided on tangible media, such as optical, magnetic, or electronic memory media. Alternatively or additionally, some or all of the functions of the image processor may be implemented in dedicated hardware, such as a custom or semi-custom integrated circuit or a programmable digital signal processor (DSP).

While the configuration in FIG. 1 shows receipt parsing comprising a single processor 22, a single memory 24 and storage device 26, other configurations of system 20 are considered to be within the spirit and scope of the present invention. For example, system 20 may be implemented using cloud computing models, wherein multiple server-based computational resources (also referred to as a cloud server) are used and accessed via a digital network. In a cloud environment all processing and storage is maintained by the cloud server. In a cloud configuration, local workstation 28 may comprise any computing device coupled to the cloud.

### Training Mode

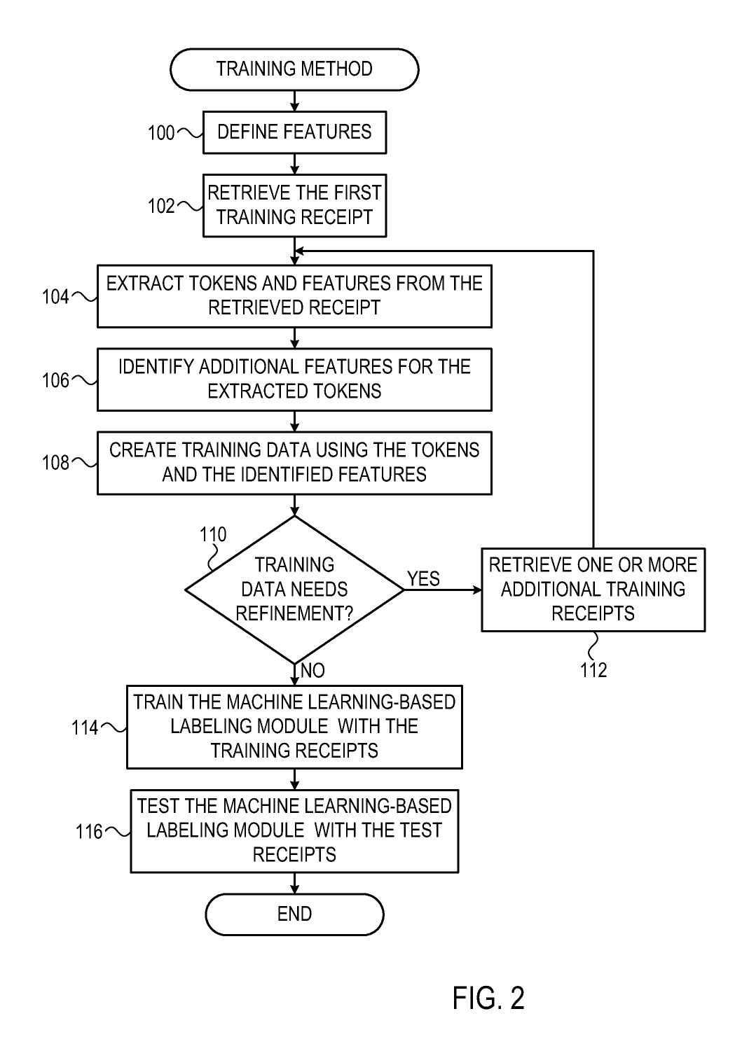

FIG. 2 is a flow diagram that schematically illustrates a method of training system 20, in accordance with an embodiment of the present invention. In a rule definition step 100, an operator (not shown) defines and inputs Features 54, via local workstation 28 executing the Itemizer Application. The defined features are typically for receipts from an initial set of merchants that were selected for the training process. To train system 20, a human expert may define features to parse receipts for the top 250 e-commerce merchants.

In a first retrieve step 102, Preprocessing Module 34 retrieves the first receipt from Training Receipts 48, and extracts tokens and features from the retrieved receipt in a preprocessing step 104. In an identify step 106, Feature Extraction Module 38 analyzes the tokens and the features extracted by Preprocessing Module 34, and identifies additional features for each of the extracted tokens. In a create step 108, Receipt Parsing Application 32 creates Training Receipts 48 using Features and Weights 54, and the tokens and the features extracted from Training Receipts 48.

In operation, Rule Engine Service Module 56 typically creates Training Receipts 48 from a different version of the receipt processed by Preprocessing Module 34 and Feature Extraction Module 38. Therefore, MALLET Module 60 may be configured to ignore the features produced by Preprocessing Module 34 and Feature Extraction Module 38 (i.e., for Module 60), and may only use the features identified by Itemizer Application 86.

In a comparison step 110, if Training Receipts 48 needs further refinement, then Preprocessing Module 34 can retrieve one or more additional training receipt in a second retrieve step 112, and the method continues with step 104. Additionally or alternatively (i.e., in step 112) system 20 can fine-tune (either automatically, or manually via Local Workstation 28) one or more modules of Receipt Parsing Application 32. For example, system 20 can change how Feature Extraction Module 38 extracts features from Raw Receipt Data 36.

If Training Receipts 48 do not need any further refinement, then in a model step 114, Receipt Parsing Application 32 uses Training receipts 48 to train Module 60 (and thereby training Receipt Language Model 62 as well) to identify labels from the tokens and the features. Finally, in a test step 116, system 20 tests trained Model 60 by having Receipt Parsing Application 32 process Test Receipts 51 using the trained Model.

To summarize the interaction between the Preprocessing Module, the Feature Extraction Module and the Machine Learning-Based Sequence Labeling Module, if the token text comprises useful features, then Preprocessing Module 34 and Feature Extraction Module 38 can explicitly transform the token text into the features, and Module 60 can determine labels for the extracted tokens from the extracted features.

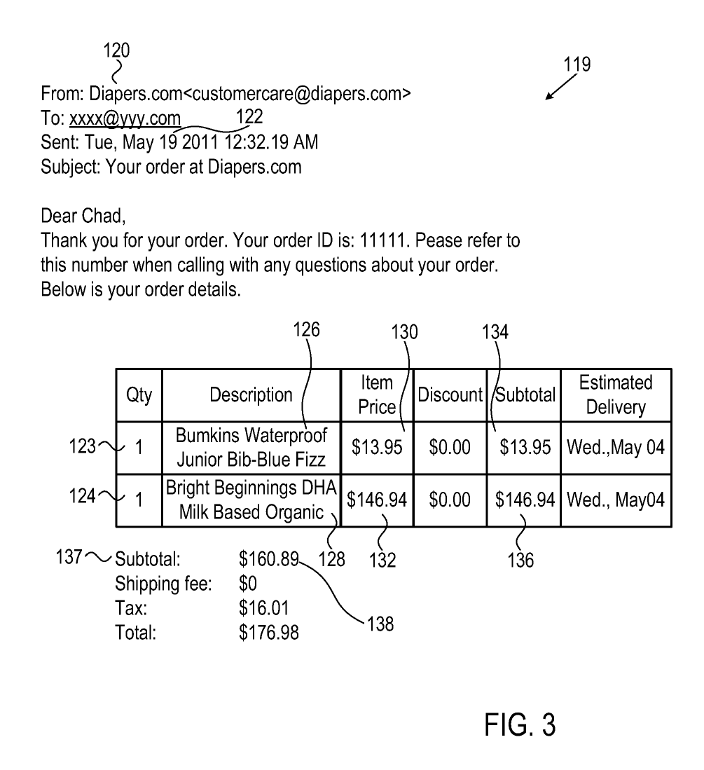

FIG. 3 is an illustration of a Training Receipt 119 (from Training Receipts 48) for a purchase from a merchant 120 on an Order Date 122, in accordance with an embodiment of the present invention. The purchase comprises Quantities 123 and 124, Item Descriptions 126 and 128, Item Prices 130 and 132, Subtotals 134 and 136, a Subtotal Text Field 137, and an Order Subtotal 138.

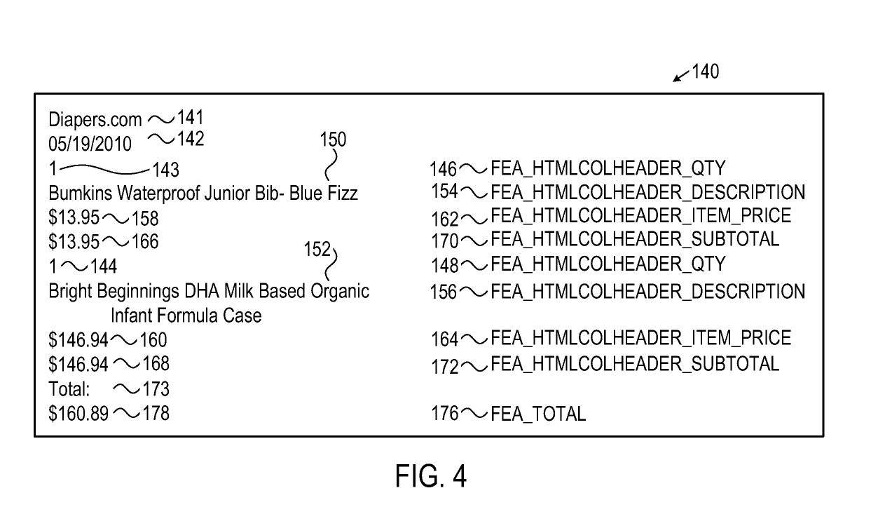

FIG. 4 is an illustration of a report 140 showing the output of Preprocessing Module 34 for Training Receipt 119, in accordance with an embodiment of the present invention. Report 140 comprises:
A Token 141 referencing Merchant 120.
A Token 142 referencing Order Date 122.
Tokens 143 and 144, and FEA_HTMLCOLHDR_QTY Features 146 and 148 referencing Quantities 122 and 124, respectively.
Tokens 150 and 152, and FEA_HTMLCOLHEADER_DESCRIPTION Features 154 and 156 referencing Item Descriptions 126 and 128, respectively.
Tokens 158 and 160, and FEA_HTMLCOLHEADER_ITEM_PRICE Features 162 and 164, referencing Item Prices 130 and 132, respectively.
Tokens 166 and 168, and FEA_HTMLCOLHEADER_SUBTOTAL Features 170 and 172, referencing Item Subtotals 134 and 136, respectively.
A Token 173 referencing Subtotal Text Field 137.
A Token 174 and a FEA_TOTAL feature 176, referencing Order Subtotal 138.

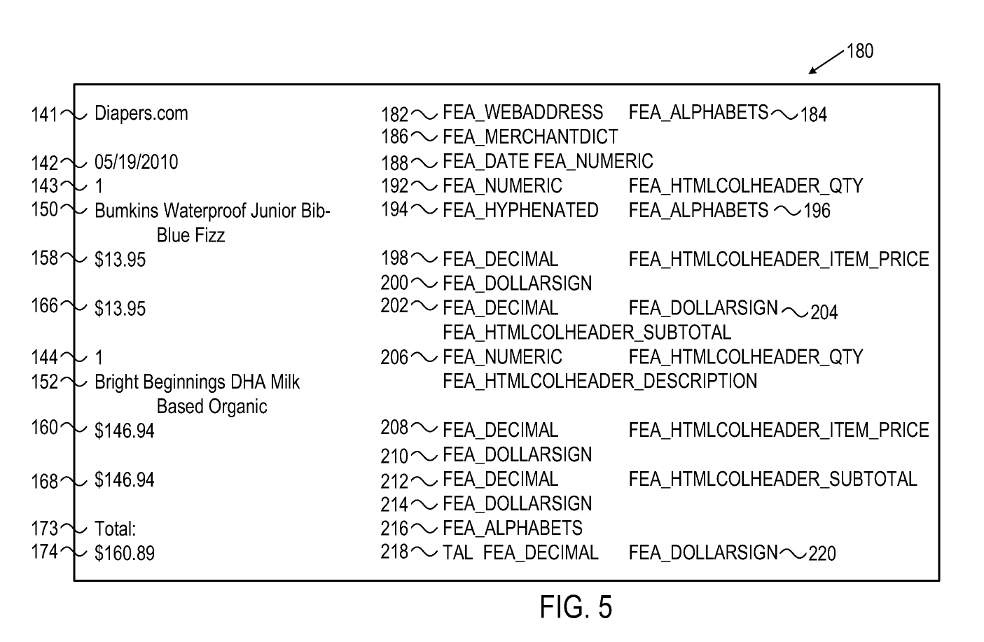

FIG. 5 is an illustration of a report 180 showing the output of Feature Extraction Module 38 for Training Receipt 119, in accordance with an embodiment of the present invention. Report 180 comprises Features 182, 184 and 186 referencing Token 141, Features 188 and 190 referencing Token 142, a Feature 192 referencing Token 143, Features 194 and 196 referencing Token 150, Features 198 and 200 referencing Token 158, Features 202 and 204 referencing Token 166, a Feature 206 referencing Token 144, Features 208 and 210 referencing Token 166, Features 212 and 214 referencing Token 168, a Feature 216 referencing Token 173, and Features 218 and 220 referencing Token 174.

Examples of features identified by Feature Extraction Module 38 include:
FEA_WEBADDRESS: A web address (e.g., for a merchant).
FEA_ALPHABETS: Alpha (i.e., “a“−”z” and “A“−”Z”) data. Other features may include numeric or alphanumeric data.
FEA_MERCHANTDICT: The text of the token was found in Merchant Dictionary 42. This does not necessarily mean that the token refers to a merchant, since there may be item names that are identical to merchant names.
FEA_DATE: Data in a date format (e.g., MM/DD/YY).
FEA_NUMERIC: Numeric data.
FEA_HYPHENATED: A hyphen within text data.
FEA_DECIMAL: A decimal point within numeric data.
FEA_DOLLAR_SIGN: A dollar sign (“$”) adjacent to numeric data.

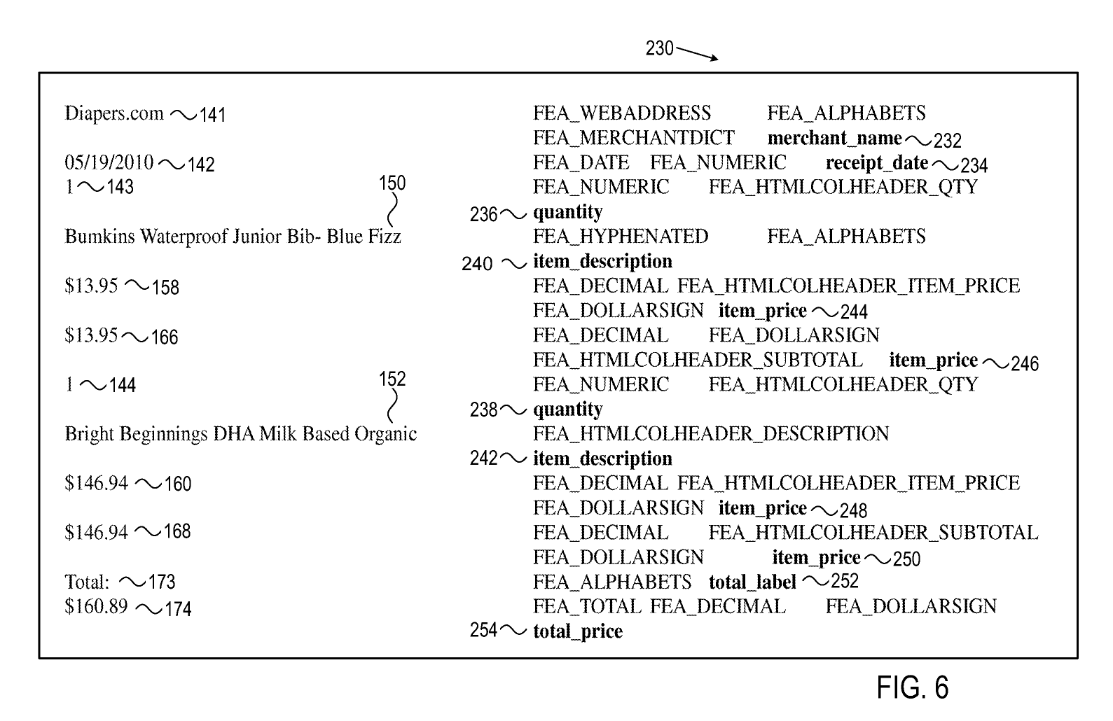

FIG. 6 is an illustration of a report 230 showing the labels identified by Module 60 for training receipt 119, in accordance with an embodiment of the present invention. Report 230 comprises:
A merchant_name Label 232 referencing Token 141.
A receipt_date Label 234 referencing Token 142.
quantity Labels 236 and 238 referencing Tokens 143 and 144, respectively.
item_description Labels 240 and 242 referencing Tokens 150 and 152, respectively.
item_price Labels 244, 246, 248 and 250, referencing Tokens 158, 166, 160 and 168, respectively.
A total_label Label 252 referencing Token 173.
A total_price Label 254 referencing Token 174.

### Test-Evaluate Mode

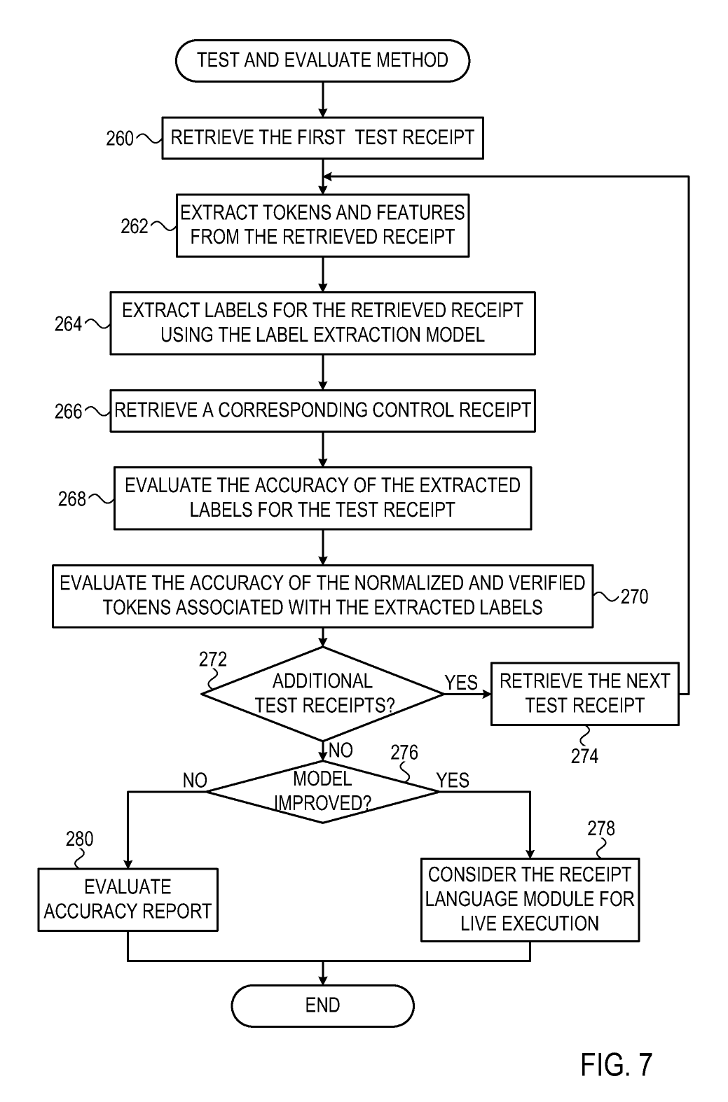

FIG. 7 is a flow diagram that schematically illustrates a method of testing and evaluating system 20, in accordance with an embodiment of the present invention. In a first retrieve step 260, Preprocessing Module 34 retrieves the first Test receipt 51, and extracts tokens and features from the retrieved Receipt in a preprocessing step 262. In a model execution step 266, Module 60 applies Receipt Language Model 62 to the tokens and features in order to identify, extract and store the features for the retrieved receipt to Automatic Annotation File 68.

In an initial step 266, Evaluation Module 64 retrieves a corresponding control receipt from Control Receipts 50, and in a first evaluation step 268, the Evaluation Module evaluates the accuracy of Receipt Language Model 62 by comparing the labels stored in Model Annotation File 68 to the labels stored in Itemizer Annotation File 66. In a second evaluation step 270, Evaluation Module 64 compares the normalized and verified labels for the retrieved Test Receipt to the labels of the corresponding Control Receipt.

Additionally, Evaluation Module 64 may test whether Verification Module 74 (in verification step 274) correctly filtered any test receipts 51 that Module 60 (using Receipt Language Model 62) labeled incorrectly. For example, if Module 60 only extracts item descriptions without their corresponding associated prices, then verification step 274 may mark this receipt as “failed”. Second evaluation step 276 can test whether retrieved test receipt 51 is marked “failed” as a result of the retrieved receipt not in accordance with the appropriate features and weights.

In some embodiments Receipt Parsing Application 32 may use different versions of the corresponding control receipt when evaluating the accuracy of the extracted labels (i.e., step 268) and when evaluating the accuracy of the normalized and verified tokens (i.e., step 270). A first version of the corresponding control receipt used by first evaluation step 268 typically includes token labels, and a second version of the corresponding control receipt used by second evaluation step 270 replaces the token labels with normalized text.

For example, the first version of a given corresponding control receipt may comprise a token “D&D Board Game” with an associated label ITEM_DESCRIPTION, and the second version of the given corresponding control receipt replaces the associated label with a brand (from Brand Dictionary 46) Dungeons_&_Dragons. The second version of the corresponding control receipt does not necessarily need to include all the text blocks that were already evaluated by first evaluation step 270, only the text blocks that need to be normalized.

To compare the hand annotations associated with the control receipts to the normalized and verified tokens associated with the labels extracted using Receipt Language Model 62, Evaluation Module 64 creates an accuracy report (discussed hereinbelow).

In a first comparison step 272, if there are additional Test Receipts 51 to be retrieved, then Preprocessing Module 34 retrieves the next Test Receipt 51, in a second retrieve step 280, and the method continues with step 262. If there are no additional Test Receipts 51, then in a second comparison step 276, if the evaluation results (i.e., the cumulative results of the Test Receipts evaluated in step 270) are acceptable, then Receipt Execution Application 32 can consider Receipt Language Model 56 for live execution in a consideration step 278. Returning to step 276, if the evaluation results are not acceptable then in a third evaluation step 280, a BPO analyst (not shown) evaluates the evaluation results, and the method ends.

After analyzing the evaluation results, the BPO analyst can identify features in order to enable Receipt Parsing Application 32 to more accurately process the retrieved receipt. Additional changes that can be made by the BPO Analyst in order to improve the accuracy receipts processed by Receipts Parsing Application (i.e., in subsequent testing) include (a) updating Dictionaries 40, (b) modifying parameters in Preprocessing Module 34, and (c) Modifying parameters in Feature Extraction Module 38.

Regardless of the evaluation results in step 282, Receipt Parsing Application 32 can store details of the evaluation to Machine Learning Database 70 for further analysis.

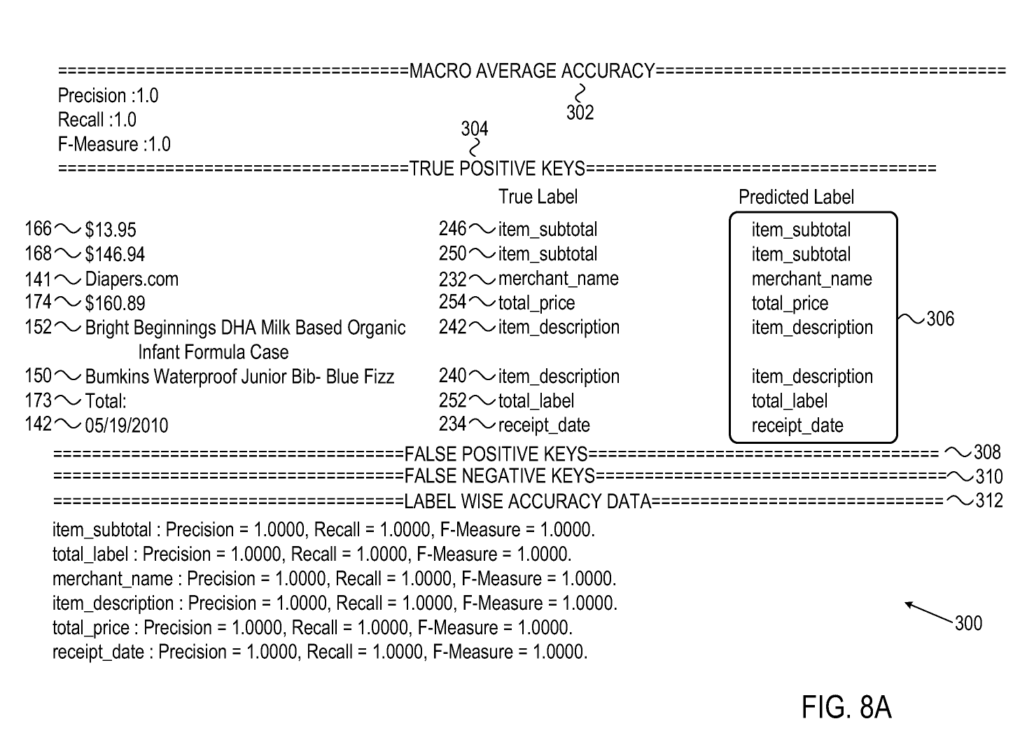

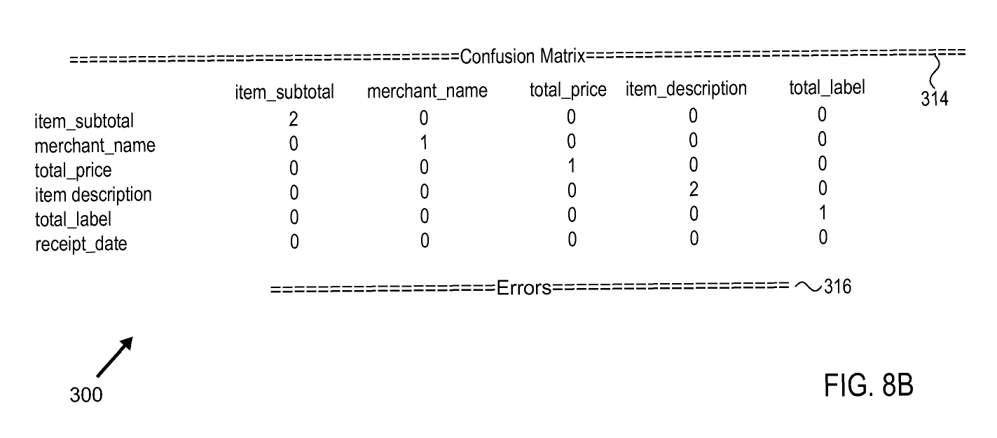

FIGS. 8A and 8B are illustrations of sections of an accuracy report 300, showing the output of Evaluation Module 64, in accordance with an embodiment of the present invention. Accuracy report 300 presents data indicating if Module 60 correctly labeled the extracted tokens. The Accuracy report can be used in step 272 of the flow diagram presented in FIG. 7 in order to determine whether Receipt Language Model 62 is ready for live execution (i.e., production mode). Accuracy report 300 comprises the following sections:
A Macro Average Accuracy section 302 that summarizes Precision, Recall and F-Measure (calculations described supra) for a given Test Receipt 51.
A True Positive Keys section 304 that presents the tokens Preprocessing Module 34 extracted from receipt 119, the labels (column True Label) that were extracted by Module 60, and Labels 306 (column Predicted Label) that were predicted by Evaluation Module 64 based on the corresponding control receipt.
A False Positive Keys section 308 that presents any false positive instances. A false positive is an instance in which a given Test Receipt 51 and its corresponding Control Receipt 50 contain identical text, but Module 60 labels the text differently from the label (i.e., that was stored to hand annotations 66) for the identical text in the corresponding Control Receipt.
A False Negative Keys section 310 that presents any false negative instances. A false negative is an instance in which a given Test Receipt 51 and a corresponding Control Receipt 50 contain identical text, where Module 60 labels the text, and there is no label (i.e., that was stored to hand annotations 66) for the identical text in the corresponding Control Receipt.
A Label Wise Accuracy Data section 312 that presents summary analytics (e.g., Precision, Recall and F-Measure) for each unique label identified by Module 60.
A confusion matrix 314 that presents a cross-tabulation for the unique labels that were extracted from the given Test Receipt by Module 60 against the unique labels that were predicted by Evaluation Module 64 based on the corresponding Control Receipt.

### Live Execution Mode

After training, testing and evaluating system 20, if accuracy report 300 indicates that Receipt Language Model 62 has reached a defined accuracy threshold, then system 20 can process live-execution receipts 52 in the Live-Execution mode. Due to the “trained” accuracy of Receipt Language Model 62, Receipt Parsing Application 32 can accurately process e-commerce receipts from the merchants that were included in the Training and the Test-Evaluate modes.

Additionally, during the Live-Execution mode, Receipt Parsing Application 32 may process Live Execution Receipts 52 from new merchants that were not included in the Training and the Test-Evaluate modes. Upon identifying a given Live Execution Receipt 52 from a new merchant (referred to herein as an “exception receipt”), Receipt Parsing Application 32 loads the exception receipt into Exception Queue 80. In some instances, Receipt Parsing Application 32, using Receipt Language Model 62, may be able to accurately parse and extract labels from the exception receipt. However, there may be instances when the Receipt Language Model cannot accurately parse and extract labels from the exception receipt.

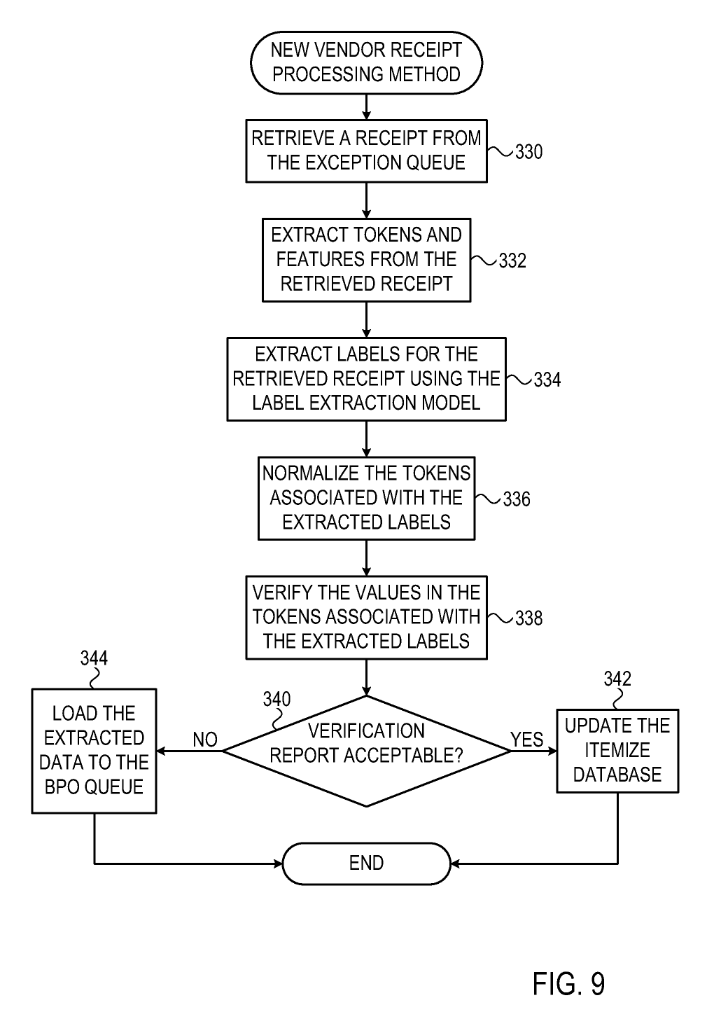

FIG. 9 is a flow diagram that schematically illustrates a live execution receipt processing method (i.e., processing a given receipt during live execution of the Machine Learning-Based Sequence Labeling Module, where the given receipt may comprise an exception receipt), in accordance with an embodiment of the present invention. In a retrieval step 330, Preprocessing Module 34 retrieves an exception receipt (i.e., unstructured data, as described supra) from Exception Queue 80, and extracts tokens and features from the retrieved exception receipt in a preprocessing step 332. A receipt in the exception queue typically indicates that the receipt includes a merchant (identified using the embodiments described herein) not matching any of the merchants in Merchant Dictionary 42.

The tokens and features indicate transaction details in the receipt. The extracted receipt typically comprises unformatted text, HTML formatted text or data extracted from a digital image of a physical receipt. In some embodiments, retrieving the receipt comprises associating an email account (e.g., email inbox 88) with a given user, identifying a given email in inbox comprising a transaction receipt, and retrieving the given email.

In a model execution step 334, Module 60 applies Receipt Language Model 62 to the tokens and features in order to apply weights to the features, and to identify and extract labels for the retrieved receipt, and associating the labels with the tokens. In a normalize step 336 Normalization Module 72 normalizes the tokens associated with the labels extracted using the Receipt Language Model, and in a verification step 338 Verification Module 74 verifies the values stored in the tokens associated with the extracted labels and creates a verification report.

In a comparison step 340, if Receipt Parsing Application 32 determines that the results of the verification report are acceptable, then in a database update step 342, the Receipt Parsing Application updates Itemize Database 82 with the extracted labels and the method terminates. However, if Receipt Parsing Application 32 determines that the results are not acceptable, then in a model update step 344 the Receipt Parsing Application loads the exception receipt into BPO Queue 90 for updating Receipt Language Model 62 (described hereinbelow in FIG. 12), and the method terminates. As in step 272 described supra, regardless of the evaluation results in step 340, Receipt Parsing Application 32 can store details of the evaluation to Machine Learning Database 70 for further analysis.

After processing a given receipt using the embodiments described herein, processor 22 can update Receipt Language Model with the extracted features, the applied weights and the associated labels. In some embodiments, processor 22 can be configured to update Receipt Language Model 62 by calculating an accuracy score (e.g., the F-measure score described supra) based on the associated (i.e., identified) labels, and the processor can update the weights based on the calculated accuracy store.

In some embodiments, processor 22 can initially create, and subsequently update a profile for a given user based on the values extracted from the receipt. A profile can be used to help predict items that a given user might be interested in purchasing, thereby enabling the creation of custom marketing programs for individual users and/or groups of users.

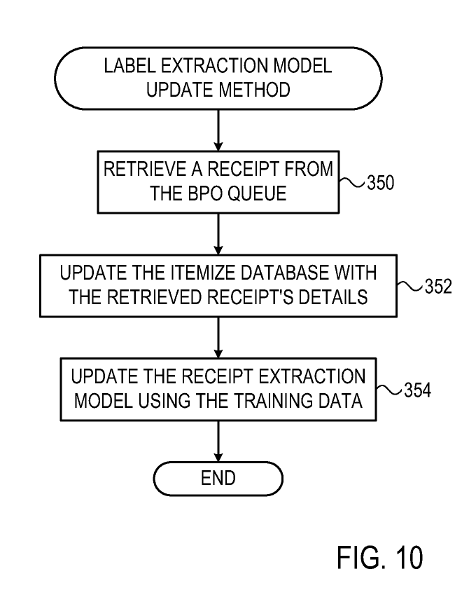

FIG. 10 is a flow diagram that schematically illustrates a method for updating Receipt Language Model 62, in accordance with an embodiment of the present invention. In a retrieve step 350, a BPO Analyst (not shown) operating Local Workstation 28 retrieves the exception receipt from BPO Queue 90, and in a database update step 352 the BPO Analyst manually updates Itemize Database 82 with appropriate labels detailing the transaction. Finally, in a model update step 354, Receipt Parsing Application 32 updates Receipt Language Model 62 with the updated Training Data.

As described in FIG. 10, processor 22 can calculate an accuracy score for each receipt processed by system 20. In embodiments of the present invention, processor 22 can convey a given receipt to BPO Queue 90 upon the accuracy score being below a specified threshold.

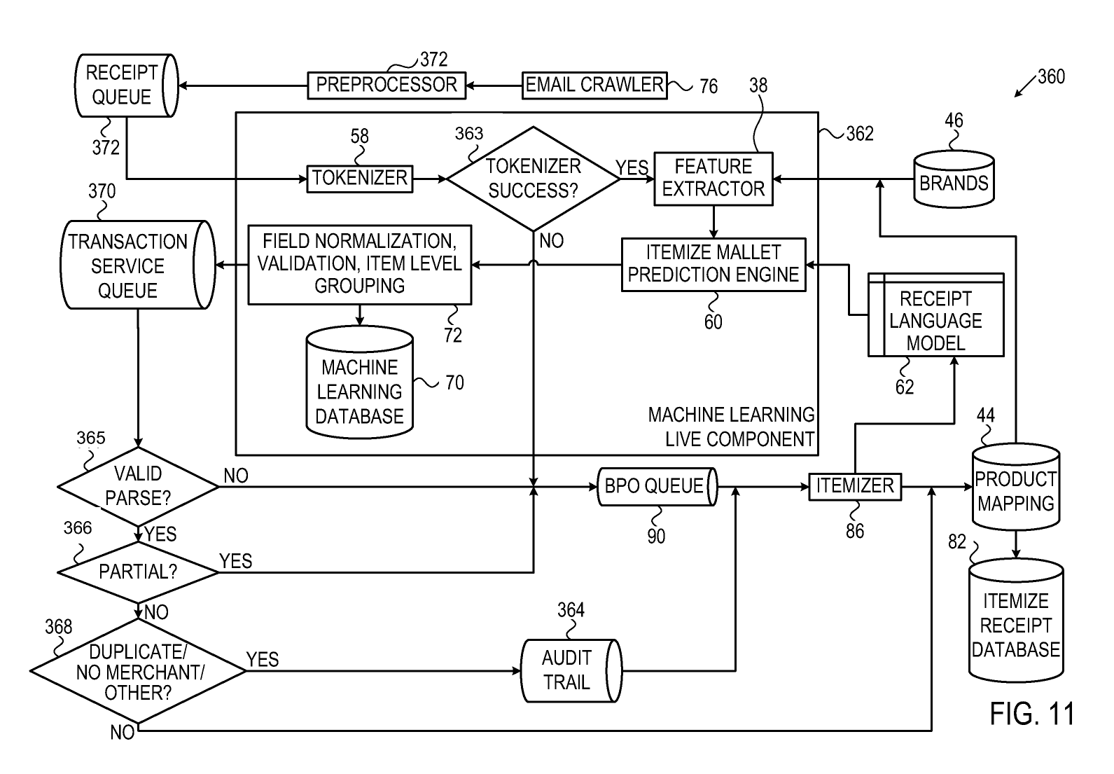

FIG. 11 is a process flow diagram 360 that schematically illustrates how modules of Receipt Parsing Application 32 interact with Receipt Language Model 62 and Itemize Database 82 while processing receipt, in accordance with an embodiment of the present invention. Email Crawling Module 76 retrieves all possible receipts from a user's Inbox 88 since the last time a user's account was crawled (or all emails if this is a new user). Preprocessing Module 34 uses an incoming sender's address to determine the merchant. A Machine Learning Live Component 362 (comprising modules 58, 38, 72, 60 and 70) retrieves a given receipt from Queue 372, and executes Tokenizer 58 to tokenize the receipt into text blocks. If the Tokenizer executes successfully (in a comparison node 363), then Feature Extractor 38 maps each text block to a list of features to that text block (e.g. “boldFont” or “is Capitalized”) and passes that mapped list of text blocks and features to the Prediction Engine 60 that utilizes Model 62. Any given labels (e.g. “totalPrice”) that Engine 60 applies to each text block is submitted to a Module 72 which normalizes text blocks where necessary, groups text blocks into sections (e.g. items with their prices), and validates that this structured receipt data is well-formed overall.

If Module 70 invalidates the parse, it is possible (not shown) to resubmit the receipt to a different Tokenizer (also not shown) or prediction engine or model to retry until validated. All Component 362 activity is logged to Database 70.

The newly structured receipt information, along with a confidence score calculated by Component 362, is then submitted to a Transaction Service Queue 370, and if in a comparison node 365, no information was extracted, the unique identifier is sent to BPO Queue 90.

If, in a comparison node 366, Component 60 did not successfully extract all the information was extracted, or if the Component determines that it could not validate the receipt or is below a confidence score threshold, then a “Partial Receipt” is submitted to BPO (17) as well. However, if this transaction has already been recorded in Database 82 (i.e., a duplicate), or this is an unknown merchant (in a comparison node 368), then the Duplicate/No Merchant document (i.e., receipt data) is submitted to an Audit Trail 364 for double-checking. Successfully parsed and validated receipt documents are submitted to Product Mapping 44.

Product Mapping Database 44 applies an algorithm to get the closest matched product in Itemize Product Dictionary Database 44, or for previously unseen products, uses external web services such as merchant API's to map this receipt item to a canonical and unique Product Name, which along with the rest of the receipt data is inserted as a receipt transaction in Itemize Database 82. Addition, these canonical Product Names, as well as Brand data 46, are in turn used by the Feature Extractor dynamically at runtime using a similar algorithm to turn on features like “Looks Like a Product Name” or “Looks Like a Brand Name” in order to better extract items via Component 5.

Finally, partial or completely unparsed receipts can be corrected by humans using a Web Application (e.g, Itemizer 86), who have no specialized knowledge of features but can read and correct missing information from a receipt. This corrected information is then conveyed to Product Mapping 44 to complete the transaction recording. This same output is also used as further training data consisting simply of the receipts ordered list of text blocks and their correct ground-truth Labels which is added to the training data used to build the Receipt Language Model (supervised learning).”

It will be appreciated that the embodiments described above are cited by way of example, and that the present invention is not limited to what has been particularly shown and described hereinabove. Rather, the scope of the present invention includes both combinations and subcombinations of the various features, including the transformations and the manipulations, described hereinabove, as well as variations and modifications thereof which would occur to persons skilled in the art upon reading the foregoing description and which are not disclosed in the prior art.

We claim:

1. A method, comprising:
retrieving, by a computer, a transaction receipt comprising unstructured data;
extracting features indicating details of the transaction from the unstructured data;
applying, using a receipt language model, weights to the features;
associating, based on the features and the weights, labels with tokens in the receipt, the tokens comprising values stored in the unstructured data; and
updating the receipt language model with the extracted features, the applied weights and the associated labels.

2. The method according to claim 1, wherein the unstructured data is selected from a list comprising unformatted text, hypertext markup language formatted text, and data extracted from an image of a physical receipt.

3. The method according to claim 1, wherein retrieving the unstructured data comprises associating an email account with a user, identifying an email in the account comprising a transaction receipt, and retrieving the identified email.

4. The method according to claim 3, and comprising updating a profile of the user with the extracted transaction details.

5. The method according to claim 1, wherein the labels comprise descriptions of the values.

6. The method according to claim 1, wherein each of the extracted values is selected from a list comprising a merchant name, an item name, an item description, and item category, an item price, a sales tax amount, a shipping charge, a handling charge, a discount, and adjustment and a total transaction amount.

7. The method according to claim 6, wherein the receipt language model accesses a database comprising one or more merchants, and wherein the merchant name does not match any of the one or more merchants in the database.

8. The method according to claim 1, wherein updating the receipt language model comprises calculating an accuracy score based on the associated labels.

9. The method according to claim 8, and comprising updating the weights based on the accuracy score.

10. The method according to claim 8, and comprising manually revising the identified features upon the accuracy score being below a specified threshold.

11. An apparatus, comprising:
a memory configured to store a transaction receipt comprising unstructured data; and
a processor configured to extract features indicating details of the transaction from the unstructured data, to apply, using a receipt language model, weights to the features, to associate, based on the features and the weights, labels with tokens in the receipt, the tokens comprising values stored in the unstructured data, and to update the receipt language model with the extracted features, the applied weights and the associated labels.

12. The apparatus according to claim 11, wherein the processor is configured to select the unstructured data from a list comprising unformatted text, hypertext markup language formatted text, and data extracted from an image of a physical receipt.

13. The apparatus according to claim 11, wherein the processor is configured to retrieve the unstructured data by associating an email account with a user, identifying an email in the account comprising a transaction receipt, and retrieving the identified email.

14. The apparatus according to claim 13, wherein the processor is configured to update a profile of the user with the extracted transaction details.

15. The apparatus according to claim 11, wherein the labels comprise descriptions of the values.

16. The apparatus according to claim 11, wherein the processor is configured to select each of the extracted values from a list comprising a merchant name, an item name, an item description, and item category, an item price, a sales tax amount, a shipping charge, a handling charge, a discount, and adjustment and a total transaction amount.

17. The apparatus according to claim 16, wherein the receipt language model accesses a database comprising one or more merchants, and wherein the merchant name does not match any of the one or more merchants in the database.

18. The apparatus according to claim 11, wherein the processor is configured to update the receipt language model by calculating an accuracy score based on the associated labels.

19. The apparatus according to claim 18, wherein the processor is configured to update the weights based on the accuracy score.

20. The apparatus according to claim 18, and comprising manually revising the identified features upon the accuracy score being below a specified threshold.

21. A computer software product comprising a non-transitory computer-readable medium, in which program instructions are stored, which instructions, when read by a computer executing a user interface, cause the computer to retrieve a transaction receipt comprising unstructured data, to extract features indicating details of the transaction from the unstructured data, to apply, using a receipt language model, weights to the features, associate, based on the features and the weights, labels with tokens in the receipt, the tokens comprising values stored in the unstructured data, and to update the receipt language model with the extracted features, the applied weights and the associated labels.
